(19) United States
(12) Patent Application Publication
(10) Pub. No.: US 2024/0344949 A1
(43) Pub. Date: Oct. 17, 2024

(54) High Accuracy - High Resolution, Frictionless, Gravity Compensated Tissue Elastometer

(71) Applicant: UNM Rainforest Innovations, Albuquerque, NM (US)

(72) Inventors: Christian Bowers, Albuquerque, NM (US); Behnam Kheyraddini Mousavi, Albuquerque, NM (US); Arash Kheyraddini Mousavi, Albuquerque, NM (US); Syed Faraz Kazim, Albuquerque, NM (US)

(73) Assignee: UNM Rainforest Innovations, Albuquerque, NM (US)

(21) Appl. No.: 18/636,010

(22) Filed: Apr. 15, 2024

Related U.S. Application Data
(60) Provisional application No. 63/495,986, filed on Apr. 13, 2023.

(51) Int. Cl. G01N 3/38

(52) U.S. Cl. CPC G01N 3/38; G01N 2203/0026; G01N 2203/0044

(57) ABSTRACT

A highly accurate, high resolution, frictionless, gravity compensated tissue elastometer. A system that offers high resolution and accuracy measurement of the different properties both in vivo and in situ, through real-time, force and deformation and displacement measurement.

### RELATED APPLICATIONS

This application claims priority to U.S. Provisional Application No. 63/495,986, filed on Apr. 13, 2023, which is incorporated herein in its entirety.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

Clinicians and researches often use tissue elastometers for evaluating the Young's modulus of soft tissues. Unlike other existing tools and reports, which provide device specific readings rather than a well stablished material property, the present invention makes it possible to directly report comparable well stablished material properties such as Young's Modulus. This allows properties measured by the device to be comparable between labs and research groups all around the world. Such values are also directly usable by other specialties and basic science researchers.

### BRIEF SUMMARY OF THE INVENTION

In one aspect, the present invention concerns a highly accurate, high resolution, frictionless, gravity compensated tissue elastometer.

In another aspect, the present invention concerns a system that offers high resolution and accuracy measurement of the different properties both in vivo and in situ, through real-time, force and deformation and displacement measurement.

In another aspect, the present invention allows static, semi-static as well as dynamic measurements.

In another aspect, the present invention includes proper details which prevent movement or disassembly of free floating members while the device is not powered.

In another aspect, the present invention is capable of accurately measuring elastic as well as viscoelastic properties of soft tissue, including but not limited to brain and tumors.

In another aspect, the present invention concerns a cylindrical outer casing making it easy to hold, use and manipulate during surgery even through miniature openings as encountered in neurosurgery.

In another aspect, the present invention concerns a device designed such that the effect of frictional forces on the measurement is ignorable.

In another aspect, the present invention concerns a design that includes and uses a combination of: Motion generation using electromagnets; Distance measurement achieved through capacitive changes; Free floating central shaft; Strategically placed ferromagnetic and nonferromagnetic materials; and Strategically placed electrically conductive and non-conductive materials.

In another aspect, the present invention concerns a device that is modular in nature. The modules may include: replaceable, or reusable after sterilization components intended to directly come in contact with patient body/tissue; and permeant components intended not to come in contact with patient and can be covered with sterile covers.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 shows a first embodiment of the present invention.

FIG. 2 shows a second embodiment of the present invention.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting, but rather to provide an understandable description of the invention.

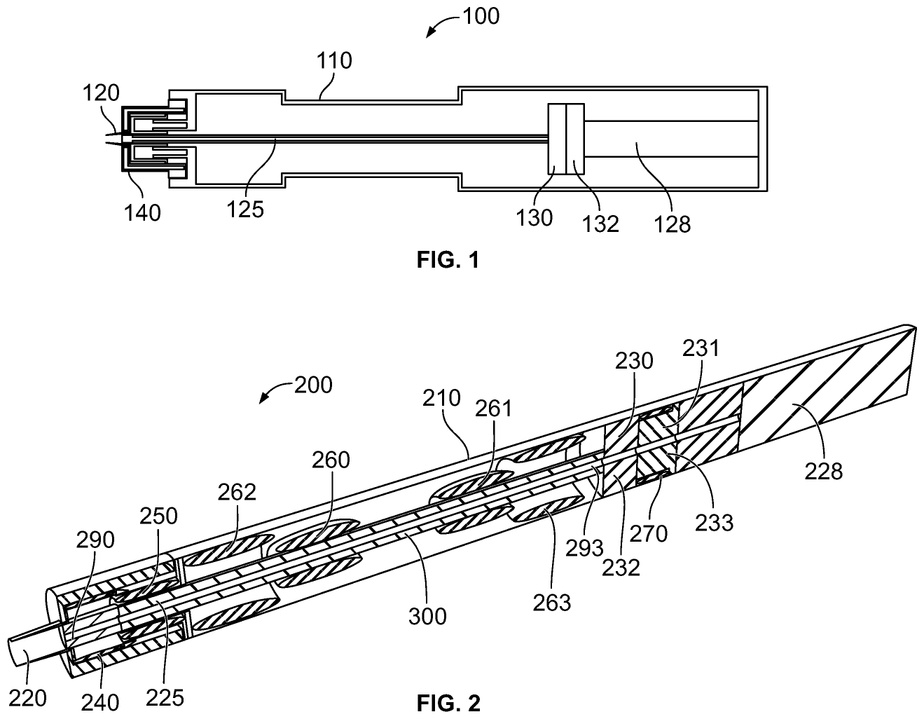

As shown in FIG. 1, in one embodiment, the present invention provides a tissue elastometer 100 comprised of a housing 110, sample cutter 120 connected to shaft 125 which is driven by a piezo 128. The piezo also generates tension with the sample. Also included are capacitive plates 230-233. The change in measured capacitance between the plates as they move towards and away from one another is used to obtain accurate measurements and sample elongation.

Also shown is annulus 140 that grabs a subject's tissue, such as brain tissue, and stabilizes it during the procedure. Annulus 140 also provides an opposing force during the cutting procedure so that the tissue does not go back as sample cutter 120 is pushed into the tissue.

As shown in FIG. 2, in another embodiment, the present invention provides a tissue elastometer 200 comprised of a housing 210, sample cutter 220 connected to shaft 225 which is driven by a piezo 228. The piezo also generates tension with the sample. Also included are capacitive plates 230-233. The change in measured capacitance between the plates as they move towards and away from one another is used to obtain accurate measurements and sample elongation.

The embodiment also includes at least one spring 240 that is used to retract cutter 220. Annular balloon 250 is used to push cutter 220 out of the device pneumatically.

Annular permanent magnets 260-261 and electrical magnets 262-263 encircle shaft 225. The magnets are used to electro magnetically drive shaft 225.

One or more springs 270 are also provided. Springs 270 may be annular and encircle shaft 225. Spring 270 is used to prevent the capacitive plates from separating as well as preventing the central shaft from falling out.

In other embodiments, shaft 225 may be a free-floating central shaft. The shaft is designed to eliminated frictional contact with surrounding structures and minimize the effects of frictional forces on the measurement.

The unique design makes it possible to compensate for the effects of gravity as the surgeon orients the device in three dimensional space. This allows the surgeon to orient the device as needed without worrying about gravity and friction affecting the measurement.

In use, the above described piezoelectric 228 and magnetic actuation systems 260-263 along with displacement sensitive capacitors 230-233 allow high resolution motion control and force/displacement measurement which directly translate to stress-strain measurement data. The capacitive measurements of movement allow high resolution displacement measurements.

Magnetic system 260-263 is used to move the central free-floating shaft 225. This serves as a secondary means of aligning the main components centrally eliminating the possibility of any unintended contacts between components.

The modular design allows sterilization of recycling of those modules which come in contact with patient tissue or replace them if needed, while covering, sterilizing and reusing the other modules.

Pneumatic 250 and mechanical systems can be used to detect different important situations including but not limited to establishment or loss of contact between different end-effectors of the device (the sections of the stealable module) with tissue.

A pneumatic system 250 is designed and used to sense contact and also seal-formation between the device and tissue as well as the means to grab and pull tissue.

A sterilizable compound end-effector 120, 140 and 220 punches a cylinder sample from the tissue (on the sides only) and tests it while grabbing the surrounding annulus of tissue. By moving the surrounding tissue as well as the deforming sample piece as a unit, the designed system also significantly minimized the effects of unintentional small movements or vibrations of the hand (during testing) from effecting the measurement.

The actuation systems may include:
1) Feedback equipped piezoelectric 128 and 228 actuation used as the main source of rectilinear high resolution motion generator.
2) Magnetic actuation composed of combination of electro- or permanent magnets 260-263 intended to
   a. Centrally align and stabilize a free-floating shaft 225 between the piezo actuator and an end-effector.
   b. Guarantee high accuracy transfer of motion from the piezo unit to the end-effector.
   c. Serve as a conduit for pneumatic (vacuum) piping to the end-effector.
3) A capacitive high sensitivity distance measurement tool 130, 132 and 230-233 intended to measure/control the relative motion between the free floating shaft and the piezoelectric actuator system. The capacitance change is used as an indication of the distance between the two plates of the capacitor. Once the piezo is actuated it moves its endplate. This reduces the distance between the right plate of the capacitor 132 (on the piezo side) closer to the left plate 130 (on the free-floating). Then the magnetic actuators 260-263 kick in to move the shaft outwards to restore the distance of the capacitive plates to the original set value. This system guarantees that the outward movement of the free floating shaft is the same as the piezo movement (or any defined proportion of it) while physically being separate from it. This means the displacement is determined from the piezo side reading and the force is determined from the magnets side. Overall allowing to obtain the force and displacement data required to characterize the tissue.

Modes of operation depending on the range of forces and displacements, or the specific situations dictated by the nature of the measurement may be as follows:
1) The piezo-actuator 128, 228 generates the intended motion under zero load and high precision guaranteed by its feedback system. The magnetic system 260-263 centrally aligns, stabilizes and moves the free-floating shaft 125, 225 such that the capacitance of the capacitive system 130, 132 or 230-233 remains unchanged. This way the motion of piezo gets indirectly but accurately transfers to the free floating load bearing shaft. The generated motion can then be used to manipulate the end-effector 120, 140 or 220. The required electric power by magnetic system to move the free-floating shaft the exact distance dictated by the piezo system is used to determine the force generated. While the induced deformation is identical to the displacement generated by the piezo. As such the accurate force and displacement data are attainable. This mode of operation is ideal for relatively larger overall displacements.
2) The piezo deformation is kept at zero. The magnetic system moves the free floating shaft induing a force and displacement on the end-effector. The displacement is determined through measuring the change in capacitance and the force is determined through the electrical power input to magnetic system. This mode is useful for very small displacements since where the displacement and capacitance values follow a linear relationship.
3) In other embodiments, two magnets 290 and 292 are located at both ends of the free-floating shaft means that the central alignment is much more effective. Basically, the larger the distance (along the axis of the shaft) between the magnets, the larger the moment and thus the better the alignment.
4) A certain displacement is generated under zero load situation. The surgeon pushes the end effector to the target tissue and the relative motions of the components is used to determine the force and displacement.
5) All the above mode can be measured with high time resolution and as such can be done in static, semi-static and dynamic situations leading to determination of an array of physical properties through force-displacement measurements done in time domain. Examples include but are not limited to, elastic properties, viscus properties, viscoelastic properties, dependance of the properties on the loading rate.

As shown in FIG. 2, design considerations for the permanent core and casing are as follows:
1) On one end, exists a centrally located piezo-electric actuator 228 one of which is permanently fixed to the cylindrical casing 210 of the device.
2) A capacitor 230-233, preferably interdigiting cinders or in the simplest form as two circular place, comes next. The capacitance changes as a function of the total effective surface areas involved which is directly dependent on the relative distance of the two halves of the capacitor. One half of the capacitor is permanently attached on the piezo actuator and the other half is permanently attached on a free floating shaft. The fact that the plates of capacitor are not supposed to touch each other, makes it possible to have a free floating shaft permanently attached to one half of the capacitor.
3) The free floating shaft 225 has two electrical magnets towards the two ends. These two magnets 262 and 262 interact with but don't touch their corresponding sister magnets 260-261 permanently fixed on the internal side of the casing. The free floating shaft is overall electrically nonconductive and is segmentally made of ferro magnetic and non-ferromagnetic materials.
4) All the components are centrally aligned and through the free floating shaft a tube 300 conducts a vacuum line towards an end-effector. This vacuum is used to detect seal formation and also to gripping the sample as will be discussed.

As shown in FIGS. 1 and 2, design considerations for the nonpermanent, sterilizable/replaceable tip are as follows:
1) There exists a hollow cylindrically shaped part 120 which non-permanently attaches to the free floating shaft 125 discussed above. It detects and grabs the surface of the specimen
2) Encasing the part above there exists a cutter that cuts a cylindrical specimen from the brain
3) Encasing the part above there exists cylindrical annular part 140 that detects contact with brain and using vacuum grabs its top surface signaling the system that contact with brain is detected and a seal is achieved. It grabs to the surrounding annular brain tissue as the cutter cuts a sample and the inner most cylindrical structure grabs and pulls the specimen in a tension test. (Or during a torsion or compression tests)

Other structural details are as follows:
1) There exists a sealed pneumatic actuators 250 that are fixed on the tip of the “permanent module” and are used to push the cutter into the brain when needed.
2) There exists mechanisms which make sure that the sections of the “sterilizable module” stay together and don't fall off
3) There exists conduits 300 to allow vacuum to be delivered to the “sterilizable tip.”

In a preferred embodiment, a puncher 120 or 220 is provided. A preferred configuration of the puncher is a cylinder with a tapered profile. This means the diameter of the cutter's tip is smaller than the diameter of the base of it. However since the tip is what cuts as it is pushed into the brain, the sample ends up to be a perfect cylinder with absolutely no taper to it. The role of the taper of the cutter is to introduce some gap between the side walls of the punched sample and the body of the puncher. This means that the sample won't touch the side walls of the cutter and no sidewall friction will be super imposed on the reading.

In yet other embodiments of the present invention, there are two separate suction mechanisms. The central disk 120 grabs the free-standing surface of the punched-out sample and can pull/rotate for measuring its properties. The second one, is a circular annulus 140 that grabs the surface of the surrounding tissue.

Supporting equipment may include:
a. Vacuum
b. High pressured air
c. Electrical measurement equipment
d. Computer/microcontroller control systems
e. Drivers and circuitry needed to run the system and perform data acquisition

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A tissue elastometer comprising:
an end-effector;
an actuation systems that includes feedback equipped piezoelectric actuation as an source of rectilinear motion generator;
magnetic actuation system composed of combination of magnets;
a centrally align, free-floating shaft located between said piezo actuator and said end-effector; and
a capacitive distance measurement tool intended to adapted to measure and control the relative motion between said free-floating shaft and said piezoelectric actuator system wherein capacitance changes may be measured by the motion of said piezo or said free floating shaft as it is attached to them on both ends.

2. The elastometer of claim 1 wherein motion of said shaft is generated using a piezoelectric actuator armed with feedback control.

3. The elastometer of claim 1 wherein motion of said shaft is generated using electromagnets.

4. The elastometer of claim 1 wherein distance measurements of said shaft are achieved through capacitive changes.

5. The elastometer of claim 1 wherein said end-effector is tapered.

6. The elastometer of claim 5 further including a central disk adapted to releasably restrain a sample.

7. The elastometer of claim 6 wherein said end-effector is adapted to pull and rotate for measuring its properties.

8. The elastometer of claim 1 further including a pneumatic system adapted provide a seal-formation with a sample and pull said end effector towards piezoelectric actuator.
